(19) United States
(12) Patent Application Publication
(10) Pub. No.: US 2026/0181685 A1
(43) Pub. Date: Jun. 25, 2026

(54) SD-WAN TUNNEL RESILIENCY IN HIGH SCALE NETWORKS

(71) Applicant: Cisco Technology, Inc., San Jose, CA (US)

(72) Inventors: Ganesh DEVENDRACHAR, MILPITAS, CA (US); Avinash SHAH, Pleasanton, CA (US); Arul Murugan MANICKAM, Mountain House, CA (US); Satyajit DAS, Lake Tapps, WA (US); Murthy Nagaraja RAGHAVENDRA, Mountain House, CA (US); Balaji SUNDARARAJAN, Fremont, CA (US)

(21) Appl. No.: 19/001,044

(22) Filed: Dec. 24, 2024

(51) Int. Cl. H04W 72/563

(52) U.S. Cl. CPC H04W 72/563

(57) ABSTRACT

In one embodiment, a method for SD-WAN tunnel resiliency in high scale networks includes maintaining a plurality of pools of resources reserved for network tunnels where the plurality of pools having a primary pool, a first backup pool for network tunnels assigned a first priority, and a second backup pool for network tunnels assigned a second priority and determining, by the process, that the primary pool contains insufficient resources to form a new network tunnel. The method further includes determining, in response to the primary pool containing insufficient resources, a priority assigned to the new network tunnel and forming, when the priority assigned to the new network tunnel meets a particular criterion, the new network tunnel by using resources from either the first backup pool or the second backup pool based on the priority assigned to the new network tunnel and whether the first backup pool or the second backup pool contain sufficient resources to form the new network tunnel.

### TECHNICAL FIELD

The present disclosure relates generally to computer networks, and, more particularly, to SD-WAN tunnel resiliency in high scale networks.

### BACKGROUND

Software-Defined Wide Area Networks (SD-WANs) are widely used at least in part because they can be deployed at high scale. As will be appreciated, a SD-WAN generally uses software-defined networking technology, such as communicating over the Internet using overlay tunnels which are encrypted when destined for internal organization locations. A typical SD-WAN deployment can be configured as a hub and spoke deployment having thousands of spokes. As a result, each hub may eventually create thousands of tunnels to all of the spokes.

This can lead to scenarios in which the total number of tunnels may exceed the number of spokes, leading to data traffic issues in the SD-WAN. More specifically, if the total number of tunnels established by the hub can exceed the total number of existing spokes when the spokes are configured with a higher number of transport locators (TLOCs). TLOCs generally allow for a cloud-based router (e.g., a virtual machine that can be deployed in the variety of private, public, and hybrid cloud computing environments that performs the functions of a physical router) to communicate with a neighboring cloud-based router's WAN transport. In these scenarios (e.g., when the maximum tunnel capacity is exceeded for a given platform), users of the SD-WAN may encounter a number of challenges.

### BRIEF DESCRIPTION OF THE DRA WINGS

The embodiments herein may be better understood by referring to the following description in conjunction with the accompanying drawings in which like reference numerals indicate identically or functionally similar elements, of which:

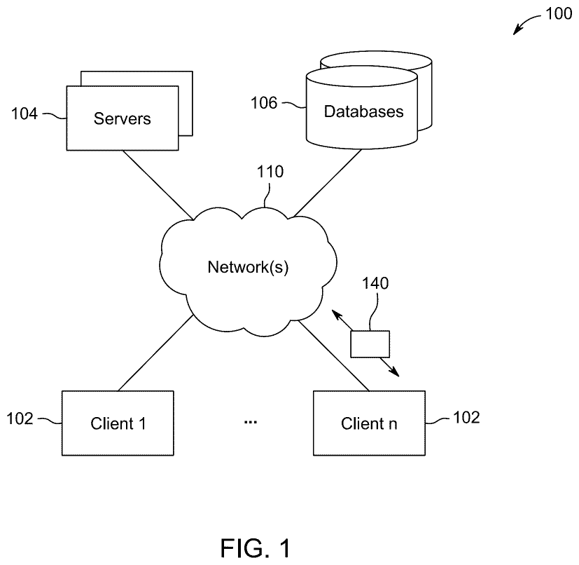

FIG. 1 illustrates an example computing system;

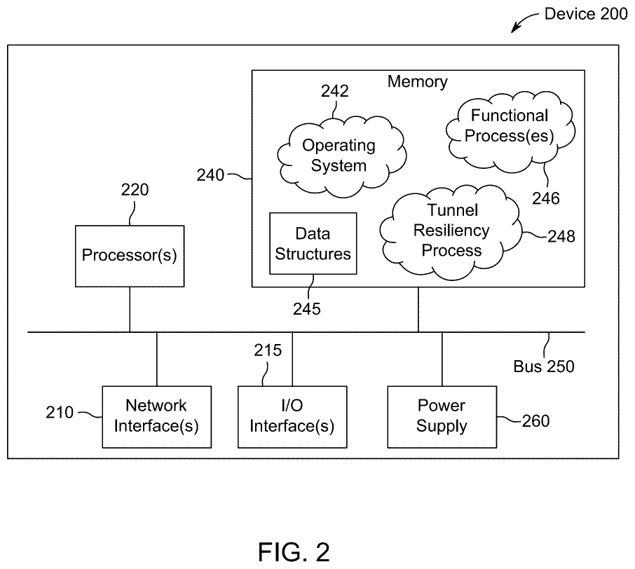

FIG. 2 illustrates an example network device/node;

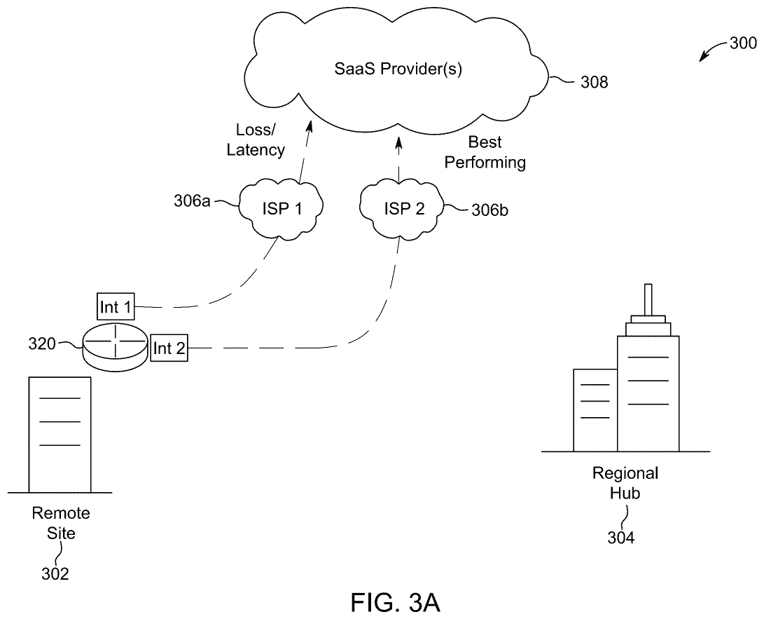

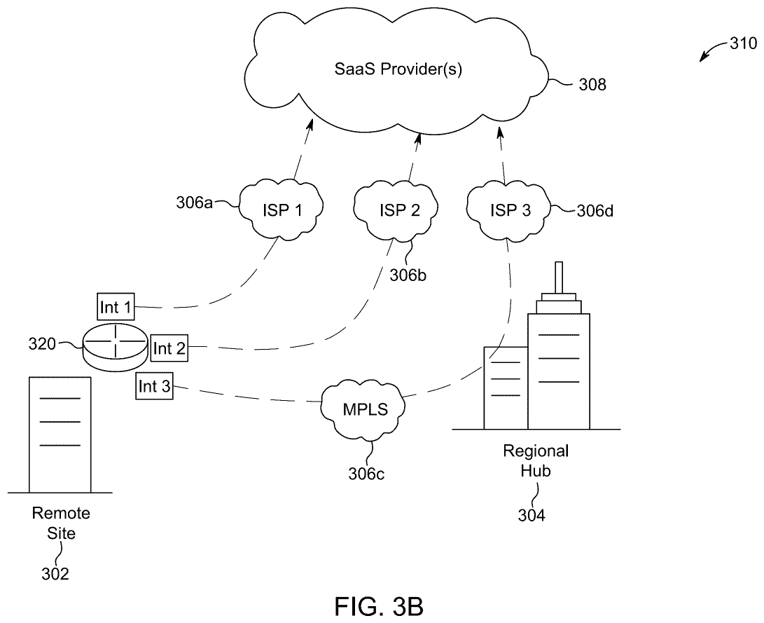

FIGS. 3A-3B illustrate example network deployments;

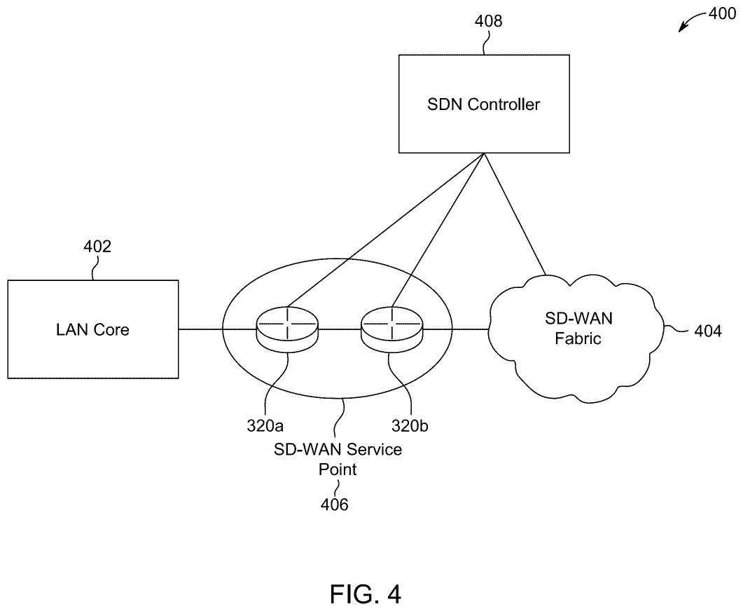

FIG. 4 illustrates an example software defined network (SDN) implementation;

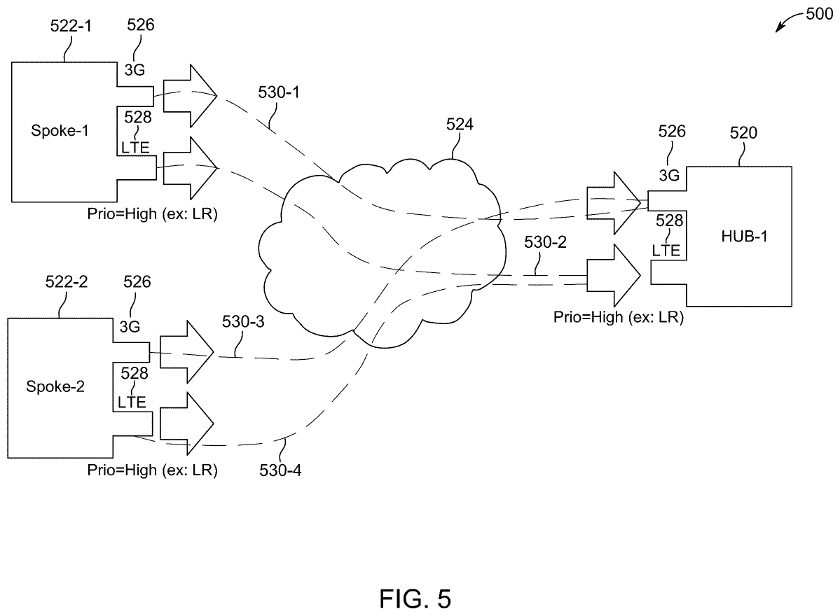

FIG. 5 illustrates an example architecture for Software-Defined Wide Area Networks (SD-WANs) tunnel resiliency in high scale networks;

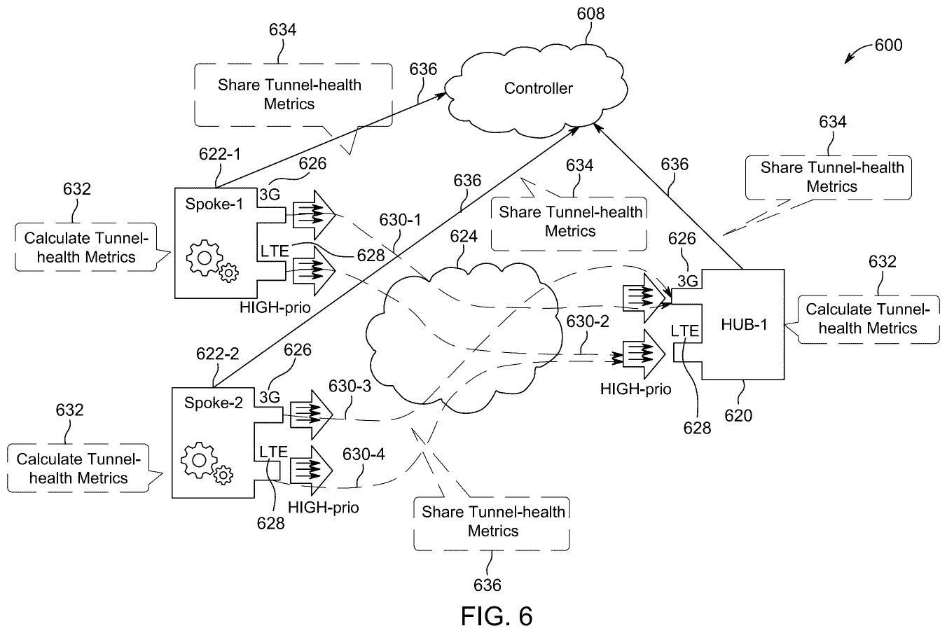

FIG. 6 illustrates another example architecture for SD-WAN tunnel resiliency in high scale networks;

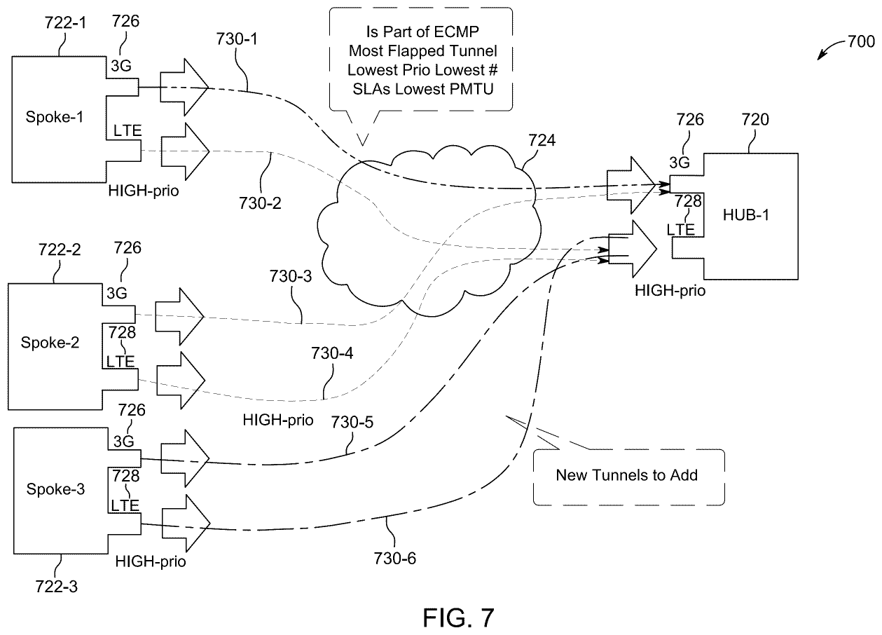

FIG. 7 illustrates yet another example architecture for SD-WAN tunnel resiliency in high scale networks;

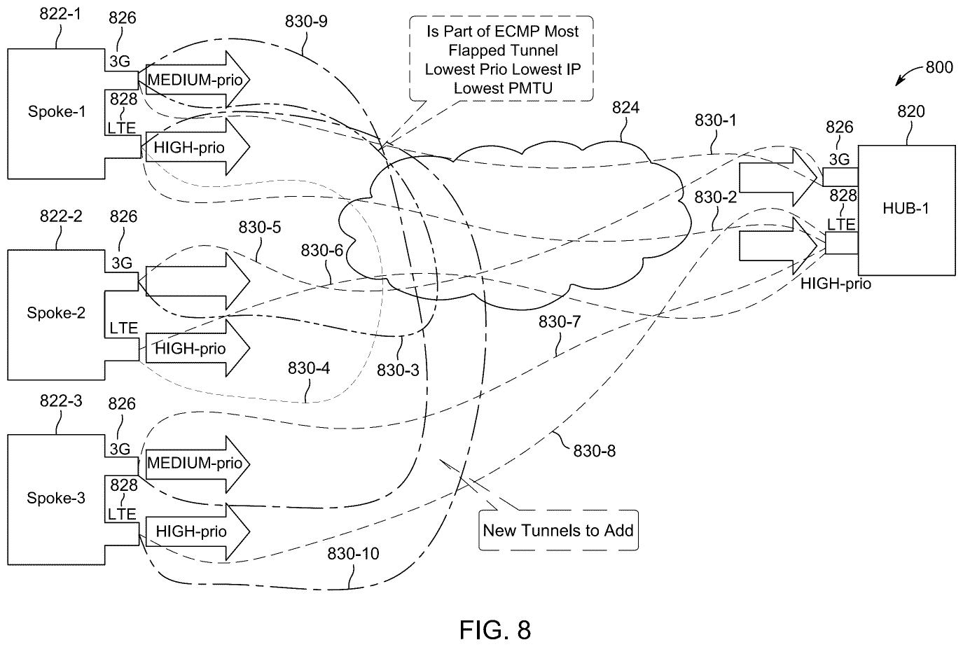

FIG. 8 illustrates yet a further example architecture for SD-WAN tunnel resiliency in high scale networks; and

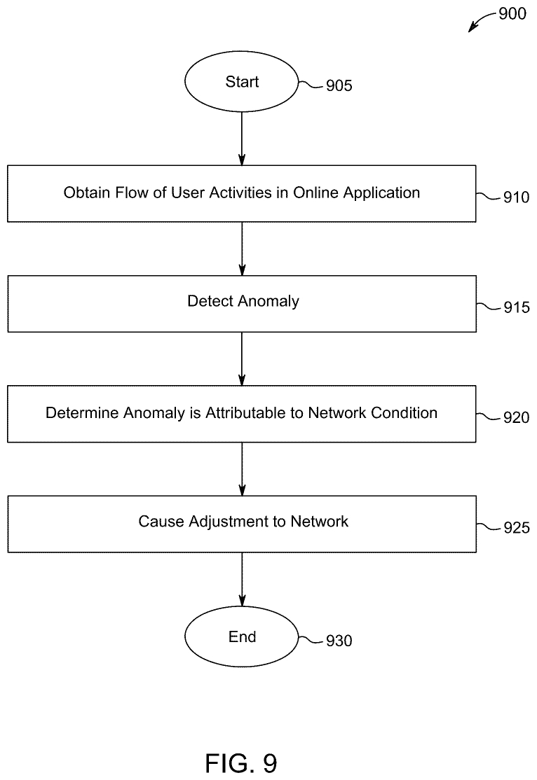

FIG. 9 illustrates an example procedure for SD-WAN tunnel resiliency in high scale networks.

### DESCRIPTION OF EXAMPLE EMBODIMENTS

### Overview

According to one or more embodiments of the disclosure, a method for Software-Defined Wide Area Networks (SD-WANs) tunnel resiliency in high scale networks includes maintaining a plurality of pools of resources reserved for network tunnels where the plurality of pools having a primary pool, a first backup pool for network tunnels assigned a first priority, and a second backup pool for network tunnels assigned a second priority and determining, by the process, that the primary pool contains insufficient resources to form a new network tunnel. The method further includes determining, in response to the primary pool containing insufficient resources, a priority assigned to the new network tunnel and forming, when the priority assigned to the new network tunnel meets a particular criterion, the new network tunnel by using resources from either the first backup pool or the second backup pool based on the priority assigned to the new network tunnel and whether the first backup pool or the second backup pool contain sufficient resources to form the new network tunnel.

Other implementations are described below, and this overview is not meant to limit the scope of the present disclosure.

### DESCRIPTION

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any given computer network. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

FIG. 1 is a schematic block diagram of an example simplified computing system (e.g., computing system 100) illustratively comprising any number of client devices (e.g., client devices 102, such as a first through nth client device), one or more servers (e.g., servers 104), and one or more databases (e.g., databases 106), where the devices may be in communication with one another via any number of networks (e.g., network(s) 110). The one or more networks (e.g., network(s) 110) may include, as would be appreciated, any number of specialized networking devices such as routers, switches, access points, etc., interconnected via wired and/or wireless connections. For example, the devices shown and/or the intermediary devices in network(s) 110 may communicate wirelessly via links based on WiFi, cellular, infrared, radio, near-field communication, satellite, or the like. Other such connections may use hardwired links, e.g., Ethernet, fiber optic, etc. The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Network(s) 110 may include, for example, network backbones or other internetworking systems, and may include various customer edge (CE) routers interconnected with provider edge (PE) routers in order to communicate across a core network to provide connectivity between devices which may be located in different geographical areas and/or on different types of local networks (e.g., local/branch networks versus data center/cloud environments). For example, these routers may be interconnected by the public Internet, a multiprotocol label switching (MPLS) virtual private network (VPN), or the like. In some implementations, a router or a set of routers may be connected to a private network (e.g., dedicated leased lines, an optical network, etc.) or a VPN (e.g., MPLS VPN) thanks to a carrier network, via one or more links exhibiting different network and service level agreement characteristics.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, smart televisions, Internet of Things (IoT) devices, autonomous devices, or any other form of computing device capable of participating with other devices via network(s) 110.

Notably, in some implementations, servers 104 and/or databases 106, including any number of other suitable devices (e.g., firewalls, gateways, and so on) may be part of a cloud-based service. In such cases, the servers and/or databases 106 may represent the cloud-based device(s) that provide certain services described herein, and may be distributed, localized (e.g., on the premise of an enterprise, or “on prem”), or any combination of suitable configurations, as will be understood in the art. Servers 104, for example, may be configured as a network controller/supervisory service located in a data center with databases 106, accordingly. For instance, servers 104 may include, in various implementations, a network management server (NMS), a dynamic host configuration protocol (DHCP) server, a constrained application protocol (CoAP) server, an outage management system (OMS), an application policy infrastructure controller (APIC), an application server, etc.

Those skilled in the art will also understand that any number of nodes, devices, links, etc. may be used in computing system 100, and that the view shown herein is for simplicity. As would also be appreciated, computing system 100 may include any number of local networks, data centers, cloud environments, devices/nodes, servers, etc. Also, those skilled in the art will further understand that while the network is shown in a certain orientation, the computing system 100 is merely an example illustration that is not meant to limit the disclosure.

For instance, smart object networks, such as sensor networks, in particular, are a specific type of network (e.g., computing system 100) having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Generally, size and cost constraints on smart object nodes (e.g., sensors) result in corresponding constraints on resources such as energy, memory, computational speed and bandwidth.

In some implementations, the techniques herein may be applied to still other network topologies and configurations. For example, the techniques herein may be applied to peering points with high-speed links, data centers, etc.

Notably, web services can be used to provide communications between electronic and/or computing devices over a network, such as the Internet. A web site is an example of a type of web service. A web site is typically a set of related web pages that can be served from a web domain. A web site can be hosted on a web server. A publicly accessible web site can generally be accessed via a network, such as the Internet. The publicly accessible collection of web sites is generally referred to as the World Wide Web (WWW).

Also, cloud computing generally refers to the use of computing resources (e.g., hardware and software) that are delivered as a service over a network (e.g., typically, the Internet). Cloud computing includes using remote services to provide a user's data, software, and computation.

Moreover, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a Software as a Service (SaaS) over a network, such as the Internet.

According to various implementations, a software-defined WAN (SD-WAN) may be used in computing system 100 to connect local networks and data center/cloud environments. In general, an SD-WAN uses a software defined networking (SDN)-based approach to instantiate tunnels on top of the physical network and control routing decisions, accordingly. For example, one tunnel may connect a customer edge (CE) router at the edge of a local network to router a remote CE router at the edge of a data center/cloud environment over an MPLS or Internet-based service provider network in a network backbone. Similarly, a second tunnel may also connect these routers over a 4G/5G/LTE cellular service provider network. SD-WAN techniques allow the WAN functions to be virtualized, essentially forming a virtual connection between local networks and data center/cloud environments on top of the various underlying connections. Another feature of SD-WAN is centralized management by a supervisory service that can monitor and adjust the various connections, as needed.

FIG. 2 is a schematic block diagram of an example node/device 200 (e.g., an apparatus) that may be used with one or more implementations described herein, e.g., as any of the nodes or devices shown in FIG. 1 above or described in further detail below. The device 200 may comprise one or more of the network interfaces 210 (e.g., wired, wireless, etc.), input/output interfaces (I/O interfaces 215, inclusive of any associated peripheral devices such as displays, keyboards, cameras, microphones, speakers, etc.), at least one processor (e.g., processor(s) 220), and a memory 240 interconnected by a system bus 250, as well as a power supply 260 (e.g., battery, plug-in, etc.).

The network interfaces 210 include the mechanical, electrical, and signaling circuitry for communicating data over physical links coupled to the computing system 100. The network interfaces may be configured to transmit and/or receive data using a variety of different communication protocols. Notably, a physical network interface (e.g., network interfaces 210) may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the implementations described herein. The processor(s) 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software processors and/or services may comprise one or more functional processes 246, and on certain devices, a tunnel resiliency process (process 248), as described herein, each of which may alternatively be located within individual network interfaces.

Notably, one or more functional processes 246, when executed by processor(s) 220, cause each device 200 to perform the various functions corresponding to the particular device's purpose and general configuration. For example, a router would be configured to operate as a router, a server would be configured to operate as a server, an access point (or gateway) would be configured to operate as an access point (or gateway), a client device would be configured to operate as a client device, and so on.

For instance, one or more functional processes 246 may include computer executable instructions executed by the processor(s) 220 to perform routing functions in conjunction with one or more routing protocols. These functions may, on capable devices, be configured to manage a routing/forwarding table (a data structure 245) containing, e.g., data used to make routing/forwarding decisions. In various cases, connectivity may be discovered and known, prior to computing routes to any destination in the network, e.g., link state routing such as Open Shortest Path First (OSPF), or Intermediate-System-to-Intermediate-System (ISIS), or Optimized Link State Routing (OLSR). For instance, paths may be computed using a shortest path first (SPF) or constrained shortest path first (CSPF) approach. Conversely, neighbors may first be discovered (e.g., a priori knowledge of network topology is not known) and, in response to a needed route to a destination, send a route request into the network to determine which neighboring node may be used to reach the desired destination. Example protocols that take this approach include Ad-hoc On-demand Distance Vector (AODV), Dynamic Source Routing (DSR), DYnamic MANET On-demand Routing (DYMO), etc. Notably, on devices not capable or configured to store routing entries, the one or more functional processes 246 may consist solely of providing mechanisms necessary for source routing techniques. That is, for source routing, other devices in the network can tell the less capable devices exactly where to send the packets, and the less capable devices simply forward the packets as directed.

In various implementations, as detailed further below, one or more functional processes 246 and/or tunnel resiliency process (process 248) may include computer executable instructions that, when executed by processor(s) 220, cause device 200 to perform the techniques described herein. To do so, in some implementations, one or more functional processes 246 and/or process 248 may utilize machine learning. In general, machine learning is concerned with the design and the development of techniques that take as input empirical data (such as network statistics and performance indicators) and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a, b, c such that the number of misclassified points is minimal. After this optimization phase (or learning phase), model M can be used very easily to classify new data points. Often, M is a statistical model, and the cost function is inversely proportional to the likelihood of M, given the input data.

In various implementations, one or more functional processes 246 and/or process 248 may employ one or more supervised, unsupervised, or semi-supervised machine learning models. Generally, supervised learning entails the use of a training set of data, as noted above, that is used to train the model to apply labels to the input data. For example, the training data may include sample network observations that do, or do not, violate a given network health status rule and are labeled as such. On the other end of the spectrum are unsupervised techniques that do not require a training set of labels. Notably, while a supervised learning model may look for previously seen patterns that have been labeled as such, an unsupervised model may instead look to whether there are sudden changes in the behavior. Semi-supervised learning models take a middle ground approach that uses a greatly reduced set of labeled training data.

Example machine learning techniques that one or more functional processes 246 and/or process 248 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), generative adversarial networks (GANs), long short-term memory (LSTM), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for timeseries), random forest classification, or the like.

In further implementations, one or more functional processes 246 and/or process 248 may also include one or more generative artificial intelligence/machine learning models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. For instance, in the context of network assurance, one or more functional processes 246 and/or process 248 may use a generative model to generate synthetic network traffic based on existing user traffic to test how the network reacts. Example generative approaches can include, but are not limited to, generative adversarial networks (GANs), large language models (LLMs), other transformer models, and the like. In some instances, one or more functional processes 246 and/or process 248 may be executed to intelligently route LLM workloads across executing nodes (e.g., communicatively connected GPUs clustered into domains).

The performance of a machine learning model can be evaluated in a number of ways based on the number of true positives, false positives, true negatives, and/or false negatives of the model. For example, the false positives of the model may refer to the number of times the model incorrectly predicted whether a network health status rule was violated. Conversely, the false negatives of the model may refer to the number of times the model predicted that a health status rule was not violated when, in fact, the rule was violated. True negatives and positives may refer to the number of times the model correctly predicted whether a rule was violated or not violated, respectively. Related to these measurements are the concepts of recall and precision. Generally, recall refers to the ratio of true positives to the sum of true positives and false negatives, which quantifies the sensitivity of the model. Similarly, precision refers to the ratio of true positives to the sum of true and false positives.

It will be apparent to those skilled in the art that other processor and memory types, including various computer-readable media, may be used to store and execute program instructions pertaining to the techniques described herein. Also, while the description illustrates various processes, it is expressly contemplated that various processes may be implemented as modules configured to operate in accordance with the techniques herein (e.g., according to the functionality of a similar process). Further, while processes may be shown and/or described separately, those skilled in the art will appreciate that processes may be routines or modules within other processes.

As noted above, in software defined WANs (SD-WANs), traffic between individual sites are sent over tunnels. The tunnels are configured to use different switching fabrics, such as MPLS, Internet, 4G or 5G, etc. Often, the different switching fabrics provide different quality of service (QoS) at varied costs. For example, an MPLS fabric typically provides high QoS when compared to the Internet, but is also more expensive than traditional Internet. Some applications requiring high QoS (e.g., video conferencing, voice calls, etc.) are traditionally sent over the more costly fabrics (e.g., MPLS), while applications not needing strong guarantees are sent over cheaper fabrics, such as the Internet.

Traditionally, network policies map individual applications to Service Level Agreements (SLAs), which define the satisfactory performance metric(s) for an application, such as loss, latency, or jitter. Similarly, a tunnel is also mapped to the type of SLA that is satisfies, based on the switching fabric that it uses. During runtime, the SD-WAN edge router then maps the application traffic to an appropriate tunnel. Currently, the mapping of SLAs between applications and tunnels is performed manually by an expert, based on their experiences and/or reports on the prior performances of the applications and tunnels.

The emergence of infrastructure as a service (IaaS) and software-as-a-service (SaaS) is having a dramatic impact of the overall Internet due to the extreme virtualization of services and shift of traffic load in many large enterprises. Consequently, a branch office or a campus can trigger massive loads on the network.

FIGS. 3A-3B illustrate example network deployments (network deployment 300, network deployment 310, respectively). As shown, a router 320 located at the edge of a remote site 302 may provide connectivity between a local area network (LAN) of the remote site 302 and one or more cloud-based, SaaS provider(s) 308. For example, in the case of an SD-WAN, router 320 may provide connectivity to SaaS provider(s) 308 via tunnels across any number of networks 306. This allows clients located in the LAN of remote site 302 to access cloud applications (e.g., Office 365™, Dropbox™, etc.) served by SaaS provider(s) 308.

As would be appreciated, SD-WANs allow for the use of a variety of different pathways between an edge device and a SaaS provider. For example, as shown in network deployment 300 in FIG. 3A, router 320 may utilize two Direct Internet Access (DIA) connections to connect with SaaS provider(s) 308. More specifically, a first interface of router 320 (e.g., a network interface 210, described previously), Int 1, may establish a first communication path (e.g., a tunnel) with SaaS provider(s) 308 via a first Internet Service Provider (ISP) 306a, denoted ISP 1 in FIG. 3A. Likewise, a second interface of router 320, Int 2, may establish a backhaul path with SaaS provider(s) 308 via a second ISP 306b, denoted ISP 2 in FIG. 3A.

FIG. 3B illustrates another network deployment 310 in which Int 1 of router 320 at the edge of remote site 302 establishes a first path to SaaS provider(s) 308 via ISP 1 and Int 2 establishes a second path to SaaS provider(s) 308 via a second ISP 306b. In contrast to the example in FIG. 3A, Int 3 of router 320 may establish a third path to SaaS provider(s) 308 via a private corporate network 306c (e.g., an MPLS network) to a private data center or regional hub 304 which, in turn, provides connectivity to SaaS provider(s) 308 via another network, such as a third ISP 306d.

Regardless of the specific connectivity configuration for the network, a variety of access technologies may be used (e.g., ADSL, 4G, 5G, etc.) in all cases, as well as various networking technologies (e.g., public Internet, MPLS (with or without strict SLA), etc.) to connect the LAN of remote site 302 to SaaS provider(s) 308. Other deployments scenarios are also possible, such as using Colo, accessing SaaS provider(s) 308 via Zscaler or Umbrella services, and the like.

FIG. 4 illustrates an example SDN implementation 400, according to various implementations. As shown, there may be a LAN core 402 at a particular location, such as remote site 302 shown previously in FIGS. 3A-3B. Connected to LAN core 402 may be one or more routers that form an SD-WAN service point 406 which provides connectivity between LAN core 402 and SD-WAN fabric 404. For instance, SD-WAN service point 406 may comprise routers 320a-320b.

Overseeing the operations of routers 320a-320b in SD-WAN service point 406 and SD-WAN fabric 404 may be an SDN controller 408. In general, SDN controller 408 may comprise one or more devices (e.g., a device 200) configured to provide a supervisory service (e.g., one or more functional processes 246), typically hosted in the cloud, to SD-WAN service point 406 and SD-WAN fabric 404. For instance, SDN controller 408 may be responsible for monitoring the operations thereof, promulgating policies (e.g., security policies, etc.), installing or adjusting IPsec routes/tunnels between LAN core 402 and remote destinations such as the regional hub 304 and/or SaaS provider(s) 308 in FIGS. 3A-3B, and the like.

As noted above, a primary networking goal may be to design and optimize the network to satisfy the requirements of the applications that it supports. So far, though, the two worlds of “applications” and “networking” have been fairly siloed. More specifically, the network is usually designed in order to provide the best SLA in terms of performance and reliability, often supporting a variety of Class of Service (CoS), but unfortunately without a deep understanding of the actual application requirements. On the application side, the networking requirements are often poorly understood even for very common applications such as voice and video for which a variety of metrics have been developed over the past two decades, with the hope of accurately representing the Quality of Experience (QoE) from the standpoint of the users of the application.

More and more applications are moving to the cloud and many do so by leveraging a SaaS model. Consequently, the number of applications that became network-centric has grown approximately exponentially with the raise of SaaS applications, such as Office 365, ServiceNow, SAP, voice, and video, to mention a few. All of these applications rely heavily on private networks and the Internet, bringing their own level of dynamicity with adaptive and fast changing workloads. On the network side, SD-WAN provides a high degree of flexibility allowing for efficient configuration management using SDN controllers with the ability to benefit from a plethora of transport access (e.g., MPLS, Internet with supporting multiple CoS, LTE, satellite links, etc.), multiple classes of service and policies to reach private and public networks via multi-cloud SaaS.

Furthermore, the level of dynamicity observed in today's network has never been so high. Millions of paths across thousands of Service Providers (SPs) and a number of SaaS applications have shown that the overall QoS(s) of the network in terms of delay, packet loss, jitter, etc. drastically vary with the region, SP, access type, as well as over time with high granularity. The immediate consequence is that the environment is highly dynamic due to:
New in-house applications being deployed;
New SaaS applications being deployed everywhere in the network, hosted by a number of different cloud providers;
Internet, MPLS, LTE transports providing highly varying performance characteristics, across time and regions;
SaaS applications themselves being highly dynamic: it is common to see new servers deployed in the network. DNS resolution allows the network for being informed of a new server deployed in the network leading to a new destination and a potentially shift of traffic towards a new destination without being even noticed.

According to various implementations, SDN controller 408 may employ application aware routing, which refers to the ability to route traffic so as to satisfy the requirements of the application, as opposed to exclusively relying on the (constrained) shortest path to reach a destination IP address. For instance, SDN controller 408 may make use of a high volume of network and application telemetry (e.g., from routers 320a-320b, SD-WAN fabric 404, etc.) so as to compute statistical and/or machine learning models to control the network with the objective of optimizing the application experience and reducing potential down times. To that end, SDN controller 408 may compute a variety of models to understand application requirements, and predictably route traffic over private networks and/or the Internet, thus optimizing the application experience while drastically reducing SLA failures and downtimes.

In other words, SDN controller 408 may first predict SLA violations in the network that could affect the QoE of an application (e.g., due to spikes of packet loss or delay, sudden decreases in bandwidth, etc.). In other words, SDN controller 408 may use SLA violations as a proxy for actual QoE information (e.g., ratings by users of an online application regarding their perception of the application), unless such QoE information is available from the provider of the online application. In turn, SDN controller 408 may then implement a corrective measure, such as rerouting the traffic of the application, prior to the predicted SLA violation. For instance, in the case of video applications, it now becomes possible to maximize throughput at any given time, which is of utmost importance to maximize the QoE of the video application. Optimized throughput can then be used as a service triggering the routing decision for specific application requiring highest throughput, in one implementation. In general, routing configuration changes are also referred to herein as routing “patches,” which are typically temporary in nature (e.g., active for a specified period of time) and may also be application-specific (e.g., for traffic of one or more specified applications).

### —SD-WAN Tunnel Resiliency in High Scale Networks—

As noted above, high scale SD-WAN deployments typically involve hub and spoke deployments having thousands of spokes. As the network evolves, the quantity of tunnels can exceed the quantity of spokes thereby giving rise to issues where tunnels, e.g., critical tunnels, such as a last resort circuit (LR) tunnel, dynamic tunnels, new tunnels, etc. may fail to establish or come “up.”

This can lead to scenarios in which the total number of tunnels may exceed the number of spokes, leading to data traffic loss, unpredictable network conditions, tunnel failure, and an inability to bring up LR tunnels, among other issues in the SD-WAN. More specifically, if the total number of tunnels established by the hub can exceed the total number of existing spokes when the spokes are configured with a higher number of transport locators (TLOCs).

For example, if a SD-WAN user has already scaled the router beyond the limits of the tunnel scale, the LR circuit tunnel may fail to come initialize (e.g., to come “up”). For example, in a scenario where a LR tunnel is configured to assist in recovery from various network tunnel events and the maximum number of tunnels for the SD-WAN network has been reached, the hub may fail to be able to establish the LR tunnel, which can lead to network traffic outages and/or an inability to add new spoke overlays.

Further, in a large-scale hub and spoke setup with a large number of spokes and a large total number of tunnels, the hub capabilities can become maxed as new TLOCs are added at the hub. For example, if the network is configured as gull mesh between the hub and the spokes, adding new TLOCs at the hub can dramatically increase the tunnel count at the hub. This can lead to issues where the tunnel scale may reach beyond the scalability at the hub. Should this occur, the network (and, hence, users of the network) may be unable to add any more new spokes and/or tunnels to the network, which can lead to a scenario in which the hub is depleted of resources and any attempt from new spokes to establish new tunnels can lead to failures, such as new device onboarding failures, and/or can cause further instability at hub for both functionality and serviceability.

It is worth noting that network churn can also affect the behavior of an SD-WAN, particularly in large-scale hub and spoke deployments. For example, an SDN controller may be able to advertise more TLOCs to a device than it can establish the tunnels for. When this happens and the maximum number of tunnels are already established some high priority tunnels that have been established may, as a result of network churn, the get deleted and a subsequent attempt to re-add these high priority tunnels may not succeed because low priority tunnels got re-added first, leading to a scenario in which there were insufficient resources for re-establishment of high priority tunnels. As will be appreciated, such scenarios can give rise to tunnel predictability issues in SD-WAN deployments.

In a hub and spoke setup with dynamic tunnels, spokes form dynamic tunnels between spokes in a spoke-to-spoke configuration when traffic is seen between them. In general, until a spoke-to-spoke tunnel comes “up” (e.g., is initialized or receives data traffic) the spoke-to-spoke traffic is routed via the hub. If the total number of tunnels on a spoke have already reached maximum values, then further attempts to bring up a dynamic tunnel will fail. Also, because dynamic tunnels are generally established only when traffic is seen between them and due to the nature of traffic liveliness in a SD-WAN deployment, there is generally no predictability to which spoke-to-spoke tunnel will succeed and which one will fail. Accordingly, if an application demands for a spoke-to-spoke tunnel, current approaches (e.g., current SD-WAN routers) generally cannot guarantee the availability of a particular and/or new spoke-to-spoke tunnel.

Moreover, because spoke-to-spoke tunnels generally provide optimized service level agreements (SLAs) (e.g., better loss, latency, jitter, etc.) because the data traffic reaches the spoke directly instead of getting relayed via the hub, it is often times desirable to utilize a spoke-to-spoke tunnel arrangement in spite of the aforementioned issues that may arise during deployment of such configurations.

In current approaches, when a network user performs network orchestration, the network user generally has to analyze and provision the tunnels within the device's tunnel scale limits. However, if the network is already provisioned with the maximum number of tunnels and network requirements change, e.g., there is a need for adding one more tunnel, etc., then the network user may have to delete an existing tunnel to make room for a new tunnel. Unfortunately, current approaches generally rely on such decisions being fully performed by the network user. This can mean that the network user may be required to know the needs of the network in order to analyze and properly decide which tunnel when, if deleted, would have the least impact on the overall network deployment. Not only is this process cumbersome, it is also prone to user error and fails to provide a deterministic methodology for tunnel deletion selection.

The techniques herein therefore allow for predictability for tunnel establishment, particularly for critical tunnels, when the SD-WAN router has reached its maximum capacity. To this end, implementations herein provide mechanisms to ensure that critical tunnels can still be established even when the SD-WAN router has reached its maximum capacity. In addition, implementations herein can provide mechanism by which existing tunnels that are least impacting the network can be deleted in order to reduce excess (e.g., non-critical) tunnels when the SD-WAN router has reached its maximum capacity.

Specifically, according to one or more embodiments of the disclosure as described in detail below, a method for SD-WAN tunnel resiliency in high scale networks includes maintaining a plurality of pools of resources reserved for network tunnels where the plurality of pools having a primary pool, a first backup pool for network tunnels assigned a first priority, and a second backup pool for network tunnels assigned a second priority and determining, by the process, that the primary pool contains insufficient resources to form a new network tunnel. The method further includes determining, in response to the primary pool containing insufficient resources, a priority assigned to the new network tunnel and forming, when the priority assigned to the new network tunnel meets a particular criterion, the new network tunnel by using resources from either the first backup pool or the second backup pool based on the priority assigned to the new network tunnel and whether the first backup pool or the second backup pool contain sufficient resources to form the new network tunnel.

Operationally, FIG. 5 illustrates an example architecture for SD-WAN tunnel resiliency in high scale networks. The architecture may be referred to herein as a “system” (e.g., system 500). As shown in FIG. 5, the system 500 includes a hub 520, which is communicatively coupled to a first spoke 522-1 and a second spoke 522-2. The hub 520, the first spoke 522-1, and the second spoke 522-2 can each have respective ports that are configured for different communication protocols, such as a 3G port 526, a long-term evolution port 528, etc.

The hub 520 can be communicatively coupled to the first spoke 522-1 and the second spoke 522-2 via a network 524. The network 524 can support a public Internet network, a multiprotocol label switching (MPLS) virtual private network (VPN), a public or private wide area network (WAN), or the like.

As shown in FIG. 5, the hub 520 can be communicatively coupled to the first spoke 522-1 and the second spoke 522-2 via a plurality of tunnels (e.g., a first tunnel 530-1, a second tunnel 530-2, a third tunnel 530-3, and a fourth tunnel 530-4, which may be referred to collectively as “tunnels 530,” herein) that “tunnel” through the network 524. As will be appreciated, the tunnels 530 can be overlay tunnels, SD-WAN bonded tunnels, and/or underlay tunnels.

In the example of FIG. 5, the 3G port 526 and the long-term evolution port 528 can have different priorities associated therewith. That is, tunnels 530 associated with the 3G port 526, a long-term evolution port 528 (or any other ports of the spokes and/or hub) can have different priorities assigned thereto. In the example of FIG. 5, the long-term evolution port 528 of the first spoke 522-1, the second spoke 522-2, and the hub 520 each has a high priority assigned thereto, while the 3G port 526 of the first spoke 522-1, the second spoke 522-2, and the hub 520 each has a lower priority (e.g., a medium priority, a low priority, etc.) assigned thereto.

In general, any SD-WAN router has a finite quantity of computing resources, which can limit the maximum number of tunnels any particular SD-WAN router can support. Therefore, once the maximum number of tunnels for a particular SD-WAN device or router (e.g., the first spoke 522-1, the second spoke 522-2, the hub 520, and/or any additional routers in a particular SD-WAN system) has been reached, the particular SD-WAN router cannot establish tunnels beyond that limit.

In such scenarios and when there is a desire to establish a new tunnel, some approaches may allow for certain computing resources to be reserved in such a way that tunnels (e.g., the tunnels 530) which are marked with a high priority will always succeed in being established. However, some tunnels are dynamic in nature and reserving resources for these dynamic tunnels may not be ideal all the time, because the finite computing resources of the router(s) may not be utilized when these dynamic tunnels are not formed. In these conditions, when a high priority tunnel is requested, implementations herein can allow for the re-routing of traffic associated with an existing dynamic tunnel which is of lower priority (e.g., low priority, medium priority, etc.) to alternative paths and replace that tunnel as to make room for the new high priority tunnel, as described in more detail below.

For example, establishing a tunnel may require various computing resources (e.g., a next hop (Nexthop), which is the next immediate router or gateway in the path taken by data packets as they travel through a network, tunnel records, Bidirectional Forwarding Detection (BFD) protocol records, blockchain records in the network, internet protocol security (IPsec) settings, etc.).

In order to ensure that adequate resources are available for establishing tunnels 530 in the network, implementations herein can allow for setting aside a limited percentage of all SD-WAN tunnel setup resources during initialization of the router(s) in the network in various resource pools. For example, during initialization of the router(s), 3% of tunnel setup resources could be reserved to establish high priority tunnels in a first backup pool, 2% of tunnel setup resources could be reserved to establish medium priority tunnels in a second backup pool, and the remaining tunnel setup resources could be assigned to a primary (e.g., a common) pool of resources. It will be appreciated that the foregoing enumerated percentages are merely used for illustration purposes and different percentages (e.g., greater than 3% of tunnel setup resources could be reserved to establish high priority tunnels, fewer than 3% of tunnel setup resources could be reserved to establish high priority tunnels, greater than 2% of tunnel setup resources could be reserved to establish medium priority tunnels, fewer than 2% of tunnel setup resources could be reserved to establish medium priority tunnels, etc.) are contemplated within the scope of the disclosure.

Implementations are not, however, limited to setting aside a limited percentage of all SD-WAN tunnel setup resources during initialization of the router(s) in the network and in some implementations, tunnel resource pool allocation can be configuration driven. For example, during network orchestration, the total number of tunnels configured with a high priority reserved at the device level can be less than or equal to 3% of the tunnel setup resources in the network. Because the SD-WAN manager can have access to device configurations and TLOC configurations, the SD-WAN manager can provide a prompt to a user of the network if a threshold percentage of tunnel setup resources in the network is reach or crossed. As mentioned above, the resources can include Nexthops, tunnel records, BFD records, IPsec settings, etc. Further, as mentioned above, the foregoing enumerated percentage of less than or equal to 3% is merely used for illustration purposes and different percentages are contemplated within the scope of the disclosure.

In some implementations, when a new tunnel is provisioned, a priority for each TLOC can be assigned as part of the tunnel configuration. For example, each TLOC can be assigned a priority of high, medium, or low (which can be the default for un-prioritized TLOCs) as part of the tunnel configuration. Implementations are not so limited, however, and other priority rankings (e.g., a priority of “1” through “5” where “1” is a highest priority, “5” is a lowest priority and integers between “1” and “5” represent priority levels that are neither the highest priority nor the lowest priority, and so on and so forth) can be assigned to the TLOCs as part of tunnel configuration. In some implementations, the priority for each TLOC can be assigned by a user, while in other implementations, the priorities for each TLOC can be assigned with the aid of machine learning and/or artificial intelligence algorithms.

Non-limiting examples of tunnel configuration parameters that can be assigned and/or prioritized as part of tunnel configuration can include interface settings, service settings, IPsec settings, service settings, etc. A non-limiting example list of tunnel configuration parameters that can be assigned could appear as follows:
interface GigabitEthernet3
tunnel-interface
encapsulation ipsec
color lte
priority HIGH
no allow-service bgp
allow-service dhcp
allow-service dns
allow-service icmp
no allow-service sshd
no allow-service netconf
no allow-service ntp
no allow-service ospf
no allow-service stun
allow-service https
no allow-service snmp
no allow-service bfd
exit

In some implementations, this information can be exchanged during TLOC advertisement via a controller associated with the control plane of the network (e.g., the SDN controller 408 of FIG. 4 and/or the controller 608 of FIG. 6). When a device in the network establishes a new tunnel, the combination of the assigned local and remote TLOC priority can dictate the priority of the tunnel to be established. Accordingly, devices (e.g., routers, edge devices, etc.) can determine the tunnel priority in accordance with the truth table “Table 1,” below. It is noted that that, as shown in Table 1, if both local and remote devices are marked as high priority then the tunnel from the first device to the second device may take more precedence over the second device (e.g., to the hub 520).

TABLE 1

| TLOC-1 (T1) | TLOC-2 (T2) | Tunnel Priority of T1 to T2 |
|---|---|---|
| HIGH | HIGH | HIGH |
| HIGH | MEDIUM | MEDIUM |
| HIGH | LOW | LOW |
| MEDIUM | MEDIUM | MEDIUM |
| MEDIUM | LOW | LOW |
| LOW | LOW | LOW |

In Table 1, the TLOCs can correspond to various devices and/or tunnels in the network. For example, TLOC-1 can be associated with the first spoke 522-1, a port (e.g., a 3G port 526, a long-term evolution port 528, etc.) associated with the first spoke 522-1, and/or a tunnel 530 associated with the first spoke 522-1. Similarly, TLOC-2 can be associated with the second spoke 522-2, a port (e.g., a 3G port 526, a long-term evolution port 528, etc.) associated with the second spoke 522-2, and/or a tunnel 530 associated with the second spoke 522-2. Stated alternatively, the TLOC priority shown in Table 1 can be utilized to determine which tunnels will be established between the first spoke 522-1 or the second spoke 522-2 and the hub 520.

Returning now to the implementation illustrated in FIG. 5, a high priority tunnel, e.g., the second tunnel 530-2 and/or the fourth tunnel 530-4, which can be a LR circuit tunnel running on a long-term evolution port 528 between the first spoke 522-1 or the second spoke 522-2 and the hub 520, can be assigned a high priority. That is, a TLOC associated with the long-term evolution port 528 can be assigned a high priority. Further, as shown in FIG. 5, a TLOC associated with the 3G port 526 may not be assigned a priority and may therefore be automatically assigned a low priority. Accordingly, the example hub and spoke topology of FIG. 5 may use the TLOCs to restrict and/or limit the tunnel formations in the network.

As a result, in the implementation illustrated in FIG. 5, the second tunnel 530-2 from the first spoke 522-1 to the hub 520 that originates from the long-term evolution port 528 of the first spoke 522-1 can be assigned a high priority. Similarly, the fourth tunnel 530-4 from the second spoke 522-2 to the hub 520 that originates from the long-term evolution port 528 of the second spoke 522-2 can be assigned a high priority. Further, as shown in FIG. 5, the first tunnel 530-1 from the first spoke 522-1 to the hub 520 that originates from the 3G port 526 of the first spoke 522-1 can be assigned a low priority, and the third tunnel 530-3 from the second spoke 522-2 to the hub 520 that originates from the 3G port 526 of the second spoke 522-2 can be assigned a low priority.

As mentioned above, on the device side (e.g., the spoke devices, routers, the hub, devices connected to the network, etc.) this priority information can be used to provision the high priority tunnels over the low priority tunnels in accordance with Table 1.

In some implementations, when a new tunnel is established, aspects of the present disclosure allow for the new tunnel to be provisioned from the common pool or “primary pool” of resources. Allocation of resources to provision a new tunnel can be allocated from the primary pool of resources by default or in response to policies set by a user. In addition, as mentioned above, a first backup pool can be reserved for creation of tunnels having a high priority and a second backup pool can be reserved for creation of tunnels having a medium priority. In the event that resources in the primary pool become exhausted and the priority of the new tunnel to be established is high or medium, resources to establish the new tunnel can be allocated from the first backup pool or the second backup pool, respectively.

In the event that an existing tunnel is replaced, e.g., to free up resources to establish a tunnel having higher priority than the tunnel that is replaced, resources associated with the replaced tunnel can be freed to the same pool from which they were allocated from. For example, if a low priority tunnel is replaced by a high priority tunnel, the resources associated with the low priority tunnel can be returned to the primary pool. Similarly, if a medium priority tunnel is replaced by a high priority tunnel, the resources associated with the low priority tunnel can be returned to the second backup pool, etc. This can ensure that tunnels having high priority (e.g., TLOCs corresponding to high priority tunnels) can always be established even during network churn and other network events where tunnels and/or tunnel resources may be shifted around.

In order to determine which tunnel(s) can be replaced, various metrics can be taken into account either by a user of the system or by the system itself. In some implementations, the network can be profiled for various parameters, such as: tunnel health, redundant paths, tunnel priority, and/or active bandwidth, among other possibilities. These parameters can be monitored and gathered during normal BFD packet exchange and a “TUNNEL_HEALTH_METRIC” can derived as follows and given a ranking (e.g., a score in a range between 1 and 10 or other suitable ranking system).
A tunnel which is meeting a lowest number of SLAs has low metric value;
A tunnel which is part of an equal-cost multi-path (ECMP) routing configuration has low metric value;
A tunnel which has high flap count has low metric value;
A tunnel having a redundant path has low metric value;
A tunnel having lowest negotiated path maximum transmission unit (PMTU) value has a low metric value; and
A tunnel with a lowest priority has a low metric value;

In some implementations, all of the above metrics, combinations of the above metrics, and/or additional metrics can be utilized to determine the “TUNNEL_HEALTH_METRIC.” This metric can then be exchanged as part of BFD packet flow and can also be sent to the SD-WAN manager as part of tunnel heath status operations.

FIG. 6 illustrates another example architecture for SD-WAN tunnel resiliency in high scale networks. The architecture may be referred to herein as a “system” (e.g., system 600). As shown in FIG. 6, the system 600 includes a hub 620, which is communicatively coupled to a first spoke 622-1 and a second spoke 622-2. The hub 620, the first spoke 622-1, and the second spoke 622-2 can each have respective ports that are configured for different communication protocols, such as a 3G port 626, a long-term evolution port 628, etc.

The hub 620 can be communicatively coupled to the first spoke 622-1 and the second spoke 622-2 via a network 624. The network 624 can support a public Internet network, a multiprotocol label switching (MPLS) virtual private network (VPN), a public or private wide area network (WAN), or the like.

As shown in FIG. 6, the hub 620 can be communicatively coupled to the first spoke 622-1 and the second spoke 622-2 via a plurality of tunnels (e.g., a first tunnel 630-1, a second tunnel 630-2, a third tunnel 630-3, and a fourth tunnel 630-4, which may be referred to collectively as “tunnels 630,” herein) that “tunnel” through the network 624. As will be appreciated, the tunnels 630 can be overlay tunnels, SD-WAN bonded tunnels, and/or underlay tunnels.

In the example of FIG. 6, the 3G port 626 and the long-term evolution port 628 can have different priorities associated therewith. That is, tunnels 630 associated with the 3G port 626, a long-term evolution port 628 (or any other ports of the spokes and/or hub) can have different priorities assigned thereto. In the example of FIG. 6, the long-term evolution port 628 of the first spoke 622-1, the second spoke 622-2, and the hub 620 each has a high priority assigned thereto, while the 3G port 626 of the first spoke 622-1, the second spoke 622-2, and the hub 620 each has a lower priority (e.g., a medium priority, a low priority, etc.) assigned thereto.

As shown in FIG. 6, the first spoke 622-1, the second spoke 622-2, and the hub 620 can calculate tunnel metrics at operation 632. In some implementations, the tunnel metrics are calculated at operation 632 as discussed above to determine the “TUNNEL_HEALTH_METRIC.” These tunnel health metrics can be shared with the network 624 and the controller 608 (which can be analogous to the SDN controller 408 of FIG. 4) as shown at operation 636.

When a determination to replace an existing tunnel with a new tunnel, either by a user or by the system 600, the SD-WAN manager can display the tunnel metrics (e.g., the tunnel metrics calculated at operation 632 and shared with the network 624 and the controller 608 at operation 636) to aid in determining which existing tunnel can be replaced with the new tunnel.

In some implementations, when an existing (e.g., “old”) tunnel is replaced with a new tunnel, the old tunnel can be added to a list of tunnels that have been replaced. This list can be maintained during operation of the network so that when resources are freed up, the old tunnels from the list can be selectively reactivated.

FIG. 7 illustrates yet another example architecture for SD-WAN tunnel resiliency in high scale networks. The architecture may be referred to herein as a “system” (e.g., system 700). As shown in FIG. 7, the system 700 includes a first spoke 722-1, a second spoke 722-2, a third spoke 722-3, and a hub 720. The hub 720, the first spoke 722-1, and the second spoke 722-2 can each have respective ports that are configured for different communication protocols, such as a 3G port 726, a long-term evolution port 728, etc.

The hub 720 can be communicatively coupled to the first spoke 722-1, the second spoke 722-2, and the third spoke 722-3 via a network 724. The network 724 can support a public Internet network, a multiprotocol label switching (MPLS) virtual private network (VPN), a public or private wide area network (WAN), or the like.

In a non-limiting example, suppose that the maximum number of tunnels 730 supported by the hub 720 is six. In this example, also suppose that two tunnels at the hub 720 are assigned a high priority (e.g., resources for the two high priority tunnels are taken from the first backup pool) and the remaining four tunnels at the hub 720 are allocated from the primary pool.

When the first spoke 722-1 and the second spoke 722-2 are added to the network, they can form four tunnels at the hub 720. For example, the first tunnel 730-1, the second tunnel 730-2 from the first spoke 722-1 and the third tunnel 730-3 and the fourth tunnel 730-4 from the second spoke 722-2 add an additional four tunnels to the hub 720. If the resources for these four tunnels from the first spoke 722-1 and the second spoke 722-2 are allocated from the primary pool, the primary pool may be exhausted (e.g., the primary pool may not have additional resources to allocate for tunnel creation.

At this stage, a third spoke 722-3 may be added to the hub 720 and formation of two new tunnels: a fifth tunnel 730-5 and a sixth tunnel 730-6, may be requested. As shown in FIG. 7, the fifth tunnel 730-5 should travel from the 3G port 726 of the third spoke 722-1 to the long-term evolution port 728 of the hub 720 and the sixth tunnel 730-6 should travel from the long-term evolution port 728 of the third spoke 722-1 to the long-term evolution port 728 of the hub 720. It is noted that in this example, the fifth tunnel 730-5 does not have an assigned priority (and therefore may have a default priority of low) while the sixth tunnel 730-6 is assigned a high priority. Accordingly, even though the primary pool is exhausted, the hub 720 will allocate resources from the first backup pool to ensure that the sixth tunnel 730-6 is formed.

Continuing with this example, suppose a user would like to ensure that the fifth tunnel 730-5 is also formed despite there being insufficient resources in the primary pool to form this tunnel. In this scenario, the SD-WAN manager can provide tunnel ranking information as described above in order to determine which tunnel can be decommissioned to make room for the new tunnel. As shown in FIG. 7, the SD-WAN manager can determine that the first tunnel 730-1 (1) is part of an ECMP, (2) is the most flapped tunnel, (3) has a lowest tunnel priority, (4) has a lowest number of SLAs, and (5) has a lowest PMTU. Based on this information, the SD-WAN manager can determine that the first tunnel 730-1 has a lowest “TUNNEL_HEALTH_METRIC” and can therefore have its resources repurposed for establishment of the new tunnel (e.g., the fifth tunnel 730-5).

FIG. 8 illustrates yet a further example architecture for SD-WAN tunnel resiliency in high scale networks. The architecture may be referred to herein as a “system” (e.g., system 800). The example of FIG. 8 illustrates a scenario in which dynamic tunnel deployment techniques are performed. As shown in FIG. 8, the system 800 includes a first spoke 822-1, a second spoke 822-2, a third spoke 822-3, and a hub 820. The hub 820, the first spoke 822-1, the second spoke 822-2, and the third spoke 822-3 can each have respective ports that are configured for different communication protocols, such as a 3G port 826, a long-term evolution port 828, etc.

The hub 820 can be communicatively coupled to the first spoke 822-1, the second spoke 822-2, and the third spoke 822-3 via a network 824. The network 824 can support a public Internet network, a multiprotocol label switching (MPLS) virtual private network (VPN), a public or private wide area network (WAN), or the like. As shown in FIG. 8, the hub 820 is communicatively coupled to the first spoke 822-1, the second spoke 822-2, and the third spoke 822-3 via a plurality of tunnels (e.g., a first tunnel 830-1, a second tunnel 830-2, a third tunnel 830-3, and a fourth tunnel 830-4, a fifth tunnel 830-5, a sixth tunnel 830-6, a seventh tunnel 830-7, an eight tunnel 830-8, a ninth tunnel 830-9, and a tenth tunnel 830-10, which may be referred to collectively as “tunnels 830,” herein) that “tunnel” through the network 824. As will be appreciated, the tunnels 830 can be overlay tunnels, SD-WAN bonded tunnels, and/or underlay tunnels.

In the dynamic tunnel deployment example of FIG. 8, the deletion of a dynamic tunnel can be performed by one of the devices (e.g., the first spoke 822-1, the second spoke 822-2, the third spoke 822-3, and/or the hub 820) without affecting traffic flow in the system 800. In some implementations, this can be made possible through a configuration driven approach to network tunnel deployment, as mentioned above.

In this implementation, when the router (e.g., the router associated with the hub 820) has established the maximum number of allowed tunnels, in order to establish a new high priority (or medium priority tunnel) tunnel, and existing low priority dynamic tunnel may be identified. The traffic from this low priority dynamic tunnel can then be rerouted via the hub 820. In some implementations, the “TUNNEL_HEALTH_METRIC” can be used to identify an existing tunnel that is a candidate to be replaced, as discussed above. In the event that one or more tunnels have a matching “TUNNEL_HEALTH_METRIC,” the tunnel with the lowest numbered internet protocol (similar to operations using virtual router redundancy protocol (VRRP)) can be chosen to be replaced.

Next, the tunnel that is identified as the candidate tunnel to be replaced is replaced, thereby freeing up tunnel allocation resources to one of the pools. Using these newly freed up resources, the new (high priority or medium priority) tunnel is established. It is noted that, due to the nature of dynamic tunnels, even though the least priority tunnel was replaced, the end-to-end traffic associated with that tunnel may still continue to flow via that router associated with the hub 820.

As shown in FIG. 8, the first spoke 822-1 has established four tunnels-a first tunnel 830-1 and a second tunnel 830-2 between the first spoke 822-1 and the hub 820 and a third tunnel 830-3 and a fourth tunnel 830-4 between the first spoke 822-1 and the second spoke 822-2. In this example, suppose that the primary pool associated with the first spoke 822-1 is exhausted and the first backup pool associated with the first spoke 822-1 is providing resources for two tunnels.

Next, the third spoke 822-3 is added to the system 800. In the event that traffic is detected between the first spoke 822-1 and the third spoke 822-3 (e.g., between the long-term evolution port 828 of the first spoke 822-1 and the long-term evolution port 828 of the third spoke 822-3), a dynamic tunnel (e.g., the tenth tunnel 830-10) may be required between the first spoke 822-1 and the third spoke 822-3. In this example, the first spoke 822-1 has enough resources in its first backup pool to establish the tenth tunnel 830-10, which is marked as high priority, and therefore the tenth tunnel 830-10 is established.

Now, traffic is detected between the first spoke 822-1 and the third spoke 822-3 (e.g., between the 3G port 826 of the first spoke 822-1 and the 3G port 826 of the third spoke 822-3), a dynamic tunnel (e.g., the ninth tunnel 830-9) may be required between the first spoke 822-1 and the third spoke 822-3. However, in this example, the first spoke 822-1 has insufficient resources in the first backup pool and the second backup pool to form the ninth tunnel 830-9, which is marked as a medium priority tunnel.

In order to solve this issue, the “TUNNEL_HEALTH_METRIC” can be used to identify an existing tunnel that is a candidate to be replaced, as discussed above. In the example of FIG. 8, it is determined that the third tunnel 830-3 (1) is part of an ECMP, (2) is the most flapped tunnel, (3) has a lowest tunnel priority, (4) has a lowest internet protocol, and (5) has a lowest PMTU. Based on this information, the SD-WAN manager can determine that the third tunnel 830-3 has a lowest “TUNNEL_HEALTH_METRIC” and can therefore have its resources repurposed for establishment of the new tunnel (e.g., the ninth tunnel 830-9).

Continuing with this example, the first spoke 822-1 can divert traffic away from the dynamic tunnel between the 3G port 826 of the first spoke 822-1 and the 3G port 826 of the second spoke 822-2 to establish a dynamic tunnel between the 3G port 826 of the first spoke 822-1 and the 3G port 826 of the second spoke 822-2. Using the resources that have been freed up from these operations, the ninth tunnel 830-9 can now be established between the 3G port 826 of the first spoke 822-1 and the 3G port 826 of the third spoke 822-3.

In closing, FIG. 9 illustrates an example procedure for SD-WAN tunnel resiliency in high scale networks. For example, a non-generic, specifically configured device (e.g., device 200, an apparatus) may perform procedure 900 by executing stored instructions (e.g., process 248). The procedure 900 may start at step 905, and continues to step 910, where, as described in greater detail above, a process maintains a plurality of pools of resources reserved for network tunnels, the plurality of pools having a primary pool, a first backup pool for network tunnels assigned a first priority, and a second backup pool for network tunnels assigned a second priority. In some implementations, a quantity of computing resources assigned to the primary pool, the first backup pool, and the second backup pool can be allocated during a network orchestration phase of initializing a computing network.

The procedure 900 may continue to step 915 where, as described above, the process determines that the primary pool contains insufficient resources to form a new network tunnel.

The procedure 900 may continue to step 920 where, as described above, the process determines, in response to the primary pool containing insufficient resources, a priority assigned to the new network tunnel.

The procedure 900 may continue to step 920 where, as described above, the process forms, when the priority assigned to the new network tunnel meets a particular criterion, the new network tunnel by using resources from either the first backup pool or the second backup pool based on the priority assigned to the new network tunnel and whether the first backup pool or the second backup pool contain sufficient resources to form the new network tunnel.

In some implementations, the particular criterion can be a high priority (e.g., a tunnel has a high priority assigned thereto). In such implementations, the procedure 900 can further include determining that there are available resources to form the new network tunnel in the first backup pool and forming the new network tunnel by using resources from the first backup pool in response to the particular criterion being the high priority.

In other implementations, the particular criterion can be a medium priority (e.g., a tunnel has a medium priority assigned thereto). In such implementations, the procedure 900 can further include determining that there are available resources to form the new network tunnel in the second backup pool and forming the new network tunnel by using resources from the second backup pool in response to the particular criterion being the medium priority.

In yet other implementations, the particular criterion can be a low priority (e.g., a tunnel has a low or unassigned priority). In such implementations, the procedure 900 can further include refraining from forming the new network tunnel in response to the particular criterion being the low priority.

In some implementations, the procedure 900 can further include determining that the first backup pool and the second backup pool do not contain sufficient resources to form the new network tunnel and replacing a particular network tunnel with the new network tunnel based on a comparison of the priority assigned to the new network tunnel and a priority assigned to the particular network tunnel. As discussed above, the priority assigned to the new network tunnel can be higher than the priority assigned to the particular network tunnel. Further, in some implementations, the comparison of the priority assigned to the new network tunnel and the priority assigned to the particular network tunnel can be based on a truth table (e.g., Table 1) that comprises a plurality of network tunnel priority ranking combinations.

As discussed above, the particular network tunnel can be, prior to replacing the particular network tunnel with the new network tunnel, an existing and operating network tunnel. Further, in some implementations, the priority assigned to the new network tunnel and the priority assigned to the particular network tunnel can be selected from a list of priority characteristics consisting of: a network tunnel health metric, a quantity of redundant network tunnel paths, an active bandwidth associated with the particular network tunnel, and a network tunnel priority metric.

In some implementations, the procedure 900 can further include deleting the particular network tunnel in response to replacing the particular network tunnel with the new network tunnel and adding information corresponding to the particular network tunnel to a list of deleted network tunnels. In such implementations, the procedure 900 can further include determining that resources associated with at least one of the primary pool, the first backup pool, and the second backup pool contain sufficient resources to reactivate the particular network tunnel and reforming the particular network tunnel in response to determining that at least one of the primary pool, the first backup pool, and the second backup pool contain sufficient resources to reform the particular network tunnel based on the list of deleted network tunnels.

Procedure 900 may end at step 930.

It should be noted that while certain steps within the procedures above may be optional as described above, the steps shown in the procedures above are merely examples for illustration, and certain other steps may be included or excluded as desired. Further, while a particular order of the steps is shown, this ordering is merely illustrative, and any suitable arrangement of the steps may be utilized without departing from the scope of the embodiments herein. Moreover, while procedures may have been described separately, certain steps from each procedure may be incorporated into each other procedure, and the procedures are not meant to be mutually exclusive.

In some implementations, an illustrative apparatus herein may comprise: one or more network interfaces to communicate with a network; a processor coupled to the one or more network interfaces and configured to execute one or more processes; and a memory configured to store a process that is executable by the processor, the process comprising: maintaining a plurality of pools of resources reserved for network tunnels, the plurality of pools having a primary pool, a first backup pool for network tunnels assigned a first priority, and a second backup pool for network tunnels assigned a second priority; determining that the primary pool contains insufficient resources to form a new network tunnel; determining, in response to the primary pool containing insufficient resources, a priority assigned to the new network tunnel; and forming, when the priority assigned to the new network tunnel meets a particular criterion, the new network tunnel by using resources from either the first backup pool or the second backup pool based on the priority assigned to the new network tunnel and whether the first backup pool or the second backup pool contain sufficient resources to form the new network tunnel.

In still other implementations, a tangible, non-transitory, computer-readable medium storing program instructions that cause a device to execute a process comprising: maintaining a plurality of pools of resources reserved for network tunnels, the plurality of pools having a primary pool, a first backup pool for network tunnels assigned a first priority, and a second backup pool for network tunnels assigned a second priority; determining that the primary pool contains insufficient resources to form a new network tunnel; determining, in response to the primary pool containing insufficient resources, a priority assigned to the new network tunnel; and forming, when the priority assigned to the new network tunnel meets a particular criterion, the new network tunnel by using resources from either the first backup pool or the second backup pool based on the priority assigned to the new network tunnel and whether the first backup pool or the second backup pool contain sufficient resources to form the new network tunnel.

The techniques described herein, therefore, provide for SD-WAN tunnel resiliency in high scale networks. As discussed above, techniques herein allow for predictability for tunnel establishment, particularly for critical tunnels, when the SD-WAN router has reached its maximum capacity. To this end, implementations herein provide mechanisms to ensure that critical tunnels can still be established even when the SD-WAN router has reached its maximum capacity. In addition, implementations herein can provide mechanism by which existing tunnels that are least impacting the network can be deleted in order to reduce excess (e.g., non-critical) tunnels when the SD-WAN router has reached its maximum capacity.

Illustratively, the techniques described herein may be performed by hardware, software, and/or firmware, (e.g., an “apparatus”) such as in accordance with the tunnel resiliency process, process 248, e.g., a “method”), which may include computer-executable instructions executed by the processor(s) 220 to perform functions relating to the techniques described herein, e.g., in conjunction with corresponding processes of other devices in the computer network as described herein (e.g., on agents, controllers, computing devices, servers, etc.). In addition, the components herein may be implemented on a singular device or in a distributed manner, in which case the combination of executing devices can be viewed as their own singular “device” for purposes of executing the process (e.g., process 248).

While there have been shown and described illustrative implementations above, it is to be understood that various other adaptations and modifications may be made within the scope of the implementations herein. For example, while certain implementations are described herein with respect to certain types of networks in particular, the techniques are not limited as such and may be used with any computer network, generally, in other implementations. Moreover, while specific technologies, protocols, architectures, schemes, workloads, languages, etc., and associated devices have been shown, other suitable alternatives may be implemented in accordance with the techniques described above. In addition, while certain devices are shown, and with certain functionality being performed on certain devices, other suitable devices and process locations may be used, accordingly.

Moreover, while the present disclosure contains many other specifics, these should not be construed as limitations on the scope of any implementation or of what may be claimed, but rather as descriptions of features that may be specific to particular implementations. Certain features that are described in this document in the context of separate implementations can also be implemented in combination in a single implementation. Conversely, various features that are described in the context of a single implementation can also be implemented in multiple implementations separately or in any suitable sub-combination. Further, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the implementations described in the present disclosure should not be understood as requiring such separation in all implementations.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true intent and scope of the implementations herein.

What is claimed is:

1. A method, comprising:
maintaining, by a process, a plurality of pools of resources reserved for network tunnels, the plurality of pools having a primary pool, a first backup pool for network tunnels assigned a first priority, and a second backup pool for network tunnels assigned a second priority;
determining, by the process, that the primary pool contains insufficient resources to form a new network tunnel;
determining, by the process and in response to the primary pool containing insufficient resources, a priority assigned to the new network tunnel; and
forming, by the process and when the priority assigned to the new network tunnel meets a particular criterion, the new network tunnel by using resources from either the first backup pool or the second backup pool based on the priority assigned to the new network tunnel and whether the first backup pool or the second backup pool contain sufficient resources to form the new network tunnel.

2. The method of claim 1, wherein the particular criterion is a high priority, and wherein the method further comprises:
determining that there are available resources to form the new network tunnel in the first backup pool; and
forming the new network tunnel by using resources from the first backup pool in response to the particular criterion being the high priority.

3. The method of claim 1, wherein the particular criterion is a medium priority, and wherein the method further comprises:
determining that there are available resources to form the new network tunnel in the second backup pool; and
forming the new network tunnel by using resources from the second backup pool in response to the particular criterion being the medium priority.

4. The method of claim 1, wherein the particular criterion is a low priority, and wherein the method further comprises:
refraining from forming the new network tunnel in response to the particular criterion being the low priority.

5. The method of claim 1, further comprising:
determining that the first backup pool and the second backup pool do not contain sufficient resources to form the new network tunnel; and
replacing a particular network tunnel with the new network tunnel based on a comparison of the priority assigned to the new network tunnel and a priority assigned to the particular network tunnel.

6. The method of claim 5, wherein the priority assigned to the new network tunnel is higher than the priority assigned to the particular network tunnel.

7. The method of claim 5, wherein the comparison of the priority assigned to the new network tunnel and the priority assigned to the particular network tunnel is based on a truth table that comprises a plurality of network tunnel priority ranking combinations.

8. The method of claim 5, wherein the particular network tunnel was, prior to replacing the particular network tunnel with the new network tunnel, an existing and operating network tunnel.

9. The method of claim 5, wherein the priority assigned to the new network tunnel and the priority assigned to the particular network tunnel is selected from a list of priority characteristics consisting of: a network tunnel health metric, a quantity of redundant network tunnel paths, an active bandwidth associated with the particular network tunnel, and a network tunnel priority metric.

10. The method of claim 5, further comprising:
deleting the particular network tunnel in response to replacing the particular network tunnel with the new network tunnel; and
adding information corresponding to the particular network tunnel to a list of deleted network tunnels.

11. The method of claim 10, further comprising:
determining that resources associated with at least one of the primary pool, the first backup pool, and the second backup pool contain sufficient resources to reactivate the particular network tunnel; and
reforming the particular network tunnel in response to determining that at least one of the primary pool, the first backup pool, and the second backup pool contain sufficient resources to reform the particular network tunnel based on the list of deleted network tunnels.

12. The method of claim 1, wherein a quantity of computing resources assigned to the primary pool, the first backup pool, and the second backup pool are allocated during a network orchestration phase of initializing a computing network.

13. An apparatus, comprising:
one or more network interfaces to communicate with a network;
a processor coupled to the one or more network interfaces and configured to execute one or more processes; and
a memory configured to store a process that is executable by the processor, the process comprising:
maintaining a plurality of pools of resources reserved for network tunnels, the plurality of pools having a primary pool, a first backup pool for network tunnels assigned a first priority, and a second backup pool for network tunnels 9 assigned a second priority;
determining that the primary pool contains insufficient resources to form a new network tunnel;
determining, in response to the primary pool containing insufficient resources, a priority assigned to the new network tunnel; and
forming, when the priority assigned to the new network tunnel meets a particular criterion, the new network tunnel by using resources from either the first backup pool or the second backup pool based on the priority assigned to the new network tunnel and whether the first backup pool or the second backup pool contain sufficient resources to form the new network tunnel.

14. The apparatus of claim 13, wherein the particular criterion is a high priority, and wherein the process further comprises:
determining that there are available resources to form the new network tunnel in the first backup pool; and
forming the new network tunnel by using resources from the first backup pool in response to the particular criterion being the high priority.

15. The apparatus of claim 13, wherein the particular criterion is a medium priority, and wherein the process further comprises:
determining that there are available resources to form the new network tunnel in the second backup pool; and
forming the new network tunnel by using resources from the second backup pool in response to the particular criterion being the medium priority.

16. The apparatus of claim 13, the process further comprising:
determining that the first backup pool and the second backup pool do not contain sufficient resources to form the new network tunnel; and
replacing a particular network tunnel with the new network tunnel based on a comparison of the priority assigned to the new network tunnel and a priority assigned to the particular network tunnel.

17. The apparatus of claim 16, wherein the priority assigned to the new network tunnel is higher than the priority assigned to the particular network tunnel.

18. The apparatus of claim 16, wherein the comparison of the priority assigned to the new network tunnel and the priority assigned to the particular network tunnel is based on a truth table that comprises a plurality of network tunnel priority ranking combinations.

19. The apparatus of claim 16, the process further comprising:
deleting the particular network tunnel in response to replacing the particular network tunnel with the new network tunnel; and
adding information corresponding to the particular network tunnel to a list of deleted network tunnels.

20. A tangible, non-transitory, computer-readable medium storing program instructions that cause a device to execute a process comprising:
maintaining a plurality of pools of resources reserved for network tunnels, the plurality of pools having a primary pool, a first backup pool for network tunnels assigned a first priority, and a second backup pool for network tunnels assigned a second priority;
determining that the primary pool contains insufficient resources to form a new network tunnel;
determining, in response to the primary pool containing insufficient resources, a priority assigned to the new network tunnel; and
forming, when the priority assigned to the new network tunnel meets a particular criterion, the new network tunnel by using resources from either the first backup pool or the second backup pool based on the priority assigned to the new network tunnel and whether the first backup pool or the second backup pool contain sufficient resources to form the new network tunnel.
